(19) United States
(12) Patent Application Publication
(10) Pub. No.: US 2025/0162046 A1
(43) Pub. Date: May 22, 2025

(54) MILLING SYSTEM FOR SEWER REHABILITATION

(71) Applicant: iPEK International GmbH, Sulzberg (DE)

(72) Inventors: Christian Engler, Obermaiselstein (DE); Markus Ostermeier, Lauben (DE); Tamara Meßmang, Oy-Mittelberg (DE)

(21) Appl. No.: 18/949,604

(22) Filed: Nov. 15, 2024

(30) Foreign Application Priority Data
Nov. 16, 2023 (DE) 10 2023 131 982.5

(51) Int. Cl. B23C 3/00

(52) U.S. Cl. CPC B23C 3/002

(57) ABSTRACT

A milling system is provided for the rehabilitation of a sewer, in particular a wastewater sewer, comprising
a motor unit, and
a milling head on which a milling tool is arranged, wherein
the milling head is coupled to the motor unit and the milling tool is movable along at least one movement axis, and
the motor unit is coupled to the milling head in such a way that it can cause the milling tool to move along at least one movement axis.

### CROSS-REFERENCE TO RELATED APPLICATIONS

This application claims priority to German Patent Application Serial No. DE 10 2023 131 982.5, filed Nov. 16, 2023, the entire disclosure of which is hereby incorporated herein by reference in its entirety.

### FIELD OF THE INVENTION

The invention relates to a milling system for the rehabilitation of or for rehabilitating a sewer, in particular a wastewater sewer.

### BACKGROUND OF THE INVENTION

It is known to use so-called milling devices in the field of sewer rehabilitation, for example to open closed side inlets or to remove roots protruding into the sewer. Such milling devices have a carriage on which a milling tool is arranged. The carriage contains drive means for driving the milling tool. The milling tool can be moved along a movement axis relative to the carriage, but this requires appropriately adapted drive means. Moving the milling tool in the axial direction, i.e. along the sewer axis, can only be accomplished by moving the carriage in this direction.

Such milling devices are controlled manually. The (manually generated) control commands are transmitted to the milling device via data lines from a control apparatus located outside the sewer.

Furthermore, the milling tools are very large in order to be able to completely open a closed side inlet with a single milling process, for example, in which the milling tool only has to be moved along the aforementioned movement axis. For side inlets with different diameters, different milling tools with a corresponding diameter are therefore usually also used. If different-sized side inlets in a sewer have to be opened, it is therefore necessary to remove the milling device from the sewer for each side inlet and to equip it with the appropriate milling tool.

During a milling process, very high restoring forces can act on the entire milling device, which requires appropriately dimensioned milling devices, such as large and heavy carriages.

### OBJECT OF THE INVENTION

The object of the present invention is therefore to avoid at least some of the disadvantages mentioned above and to provide a milling system that is easier and at the same time safe to handle.

### SUMMARY OF THE INVENTION

This object is achieved by a milling system for the rehabilitation of a sewer, in particular a wastewater sewer, and by a sewer inspection system, which comprises a carriage and a milling system according to the invention, as per the independent claims. Advantageous embodiments of the invention are specified in the dependent claims.

A milling system is therefore provided for the rehabilitation of a sewer, in particular a wastewater sewer, comprising
a motor unit, and
a milling head on which a milling tool is arranged,
wherein
the milling head is coupled to the motor unit and the milling tool is movable along at least one movement axis, and
the motor unit is coupled to the milling head in such a way that it can cause the milling tool to move along the at least one movement axis.

It is advantageous for the at least one movement axis to comprise
a first movement axis,
a second movement axis, and
a third movement axis,
wherein the milling tool is movable along the first, second and/or third movement axes, and wherein the motor unit is coupled to the milling head in such a way that it can cause the milling tool to move along the first and/or second and/or third movement axis.

The milling tool may therefore be positioned anywhere in the space.

In one embodiment of the invention, these three movement axes can be perpendicular to one another. Optionally, they can also each be arranged at different angles to one another.

The milling tool can be moved in each of these three axes independently of the other two axes in each case. One advantage thereof consists in that a carriage on which the milling system can be arranged does not have to change its position in the sewer during a milling process. Furthermore, due to the mobility of the milling tool along these three movement axes, different-sized regions in the sewer can be machined without having to change the milling tool-for example, side inlets with different diameters can be opened with the same milling tool.

It is advantageous if the motor unit is coupled to the milling head by means of a gear unit, in particular an angular gear unit, wherein each movement axis is assigned a gear of the gear unit, wherein the gears of the gear unit can be operated independently of one another. The milling head can thus be particularly compact in terms of its dimensions.

In one embodiment of the invention, it may be advantageous if the motor unit comprises a plurality of motors, in particular electric motors, wherein each movement axis is assigned a motor of the plurality of motors, and wherein each motor is adapted to move the milling tool along the corresponding movement axis. In this case, the motors can be arranged in the milling head, preferably directly on the corresponding movement axes.

In one embodiment of the invention, it can be advantageous if
the milling head is rotatable about an axis of rotation, and/or
the milling tool is pivotable about a pivot axis,
wherein the axis of rotation and/or the pivot axis is/are each assigned a gear of the gear unit or a motor of the plurality of motors.

This allows up to two additional degrees of freedom for the milling tool, which significantly increases flexibility in terms of possible uses.

It is advantageous if the milling system further comprises a control device which is coupled to a sensor system and to the motor unit, wherein the control device is adapted to control the motor unit on the basis of the measured values detected by the sensor system.

The sensor system can comprise
at least one force sensor for detecting at least one force acting on the milling tool, and/or
a temperature sensor for detecting a temperature of the milling tool, and/or
a torque sensor for detecting the torque acting on the milling tool,
wherein, according to the invention, the sensor system is not limited to these three types of sensors. Other sensors may additionally be provided if they have proven advantageous for controlling the motor unit by means of the control device.

As a result of providing these or, optionally, additional sensors and of the control device taking the measured values into account, the rotational speed or advancement of the milling tool, for example, can be adjusted or controlled. Forces acting on the milling tool and thus on a carriage on which the milling device is arranged can thus be significantly reduced without adversely affecting the efficiency of the milling process. The mechanical load on the milling device (including the milling tool) and the vehicle is thereby significantly reduced, leading to a longer service life of the entire system while simultaneously requiring less maintenance.

In one embodiment of the invention, the control device can be adapted to control the motor unit according to a predetermined program sequence. A milling process can thus be at least partially automated, for example by means of a cycle control. For example, a program can be provided that is used to move the milling head into a predetermined position (e.g. with respect to the three movement axes) or is used to move the milling tool along a predetermined path.

In one embodiment of the invention, the milling system can be arrangeable on a carriage of a sewer inspection system.

In a further aspect of the invention, a sewer inspection system is provided, comprising a carriage and a milling system according to the invention.

### BRIEF DESCRIPTION OF THE DRAWINGS

Further details and features of the invention as well as specific, in particular advantageous exemplary embodiments of the invention become apparent from the following description in conjunction with the drawing. In the figures:

FIGS. 1A and 1B are perspective views of a milling system according to the invention comprising a milling tool that is pivoted upward (FIG. 1A) and a milling tool that is pivoted downward (FIG. 1B);

FIGS. 2A and 2B are lateral views of a milling system according to the invention, comprising a milling tool that is pivoted upward (FIG. 2A) and a milling tool that is pivoted downward (FIG. 2B);

FIGS. 3A and 3B are views from the front of a milling system according to the invention, comprising a milling tool that is pivoted upward (FIG. 3A) and a milling tool that is pivoted downward (FIG. 3B);

FIGS. 4A and 4B are plan views of a milling system according to the invention, comprising a milling tool that is pivoted upward (FIG. 4A) and a milling tool that is pivoted downward (FIG. 4B);

FIGS. 5A-5C are perspective views of a milling system according to the invention, which is arranged on a lifting system of a carriage, in different positions of the lifting system and different pivoted positions of the milling tool; and

FIG. 6 is a block diagram of a milling system according to the invention.

### DETAILED DESCRIPTION OF THE INVENTION

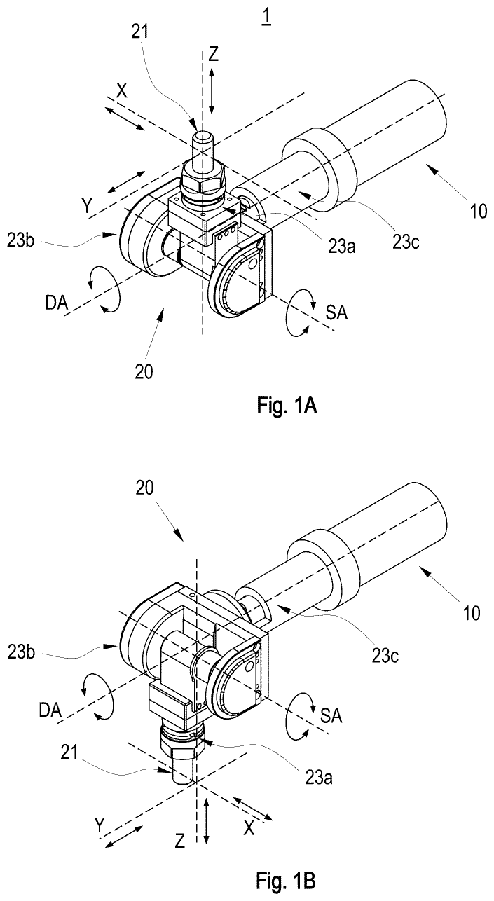

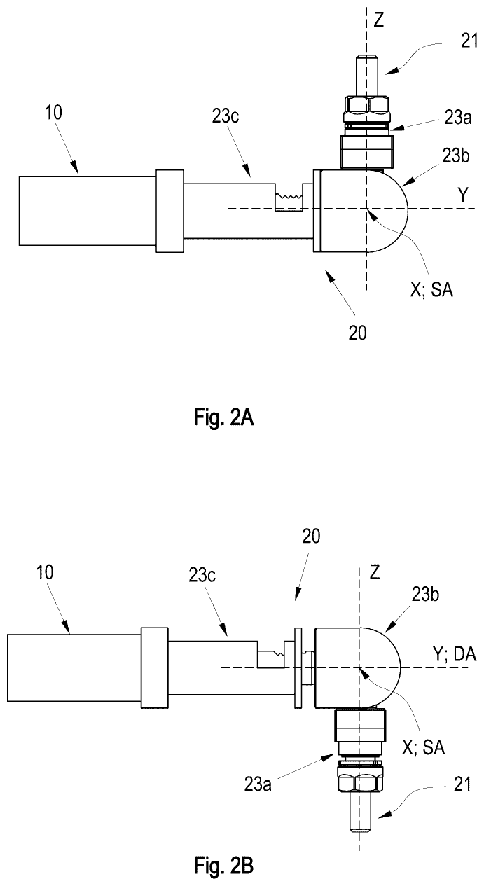

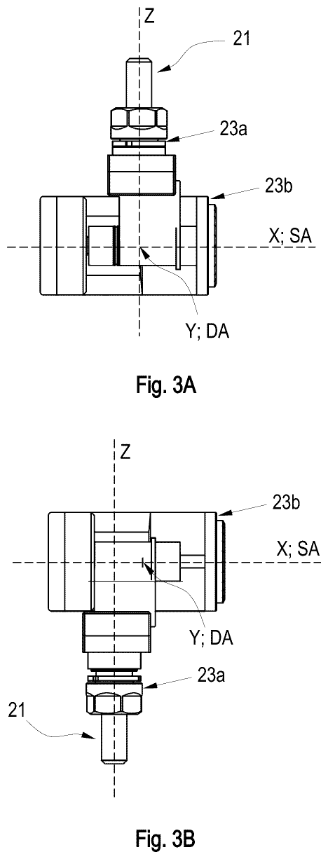

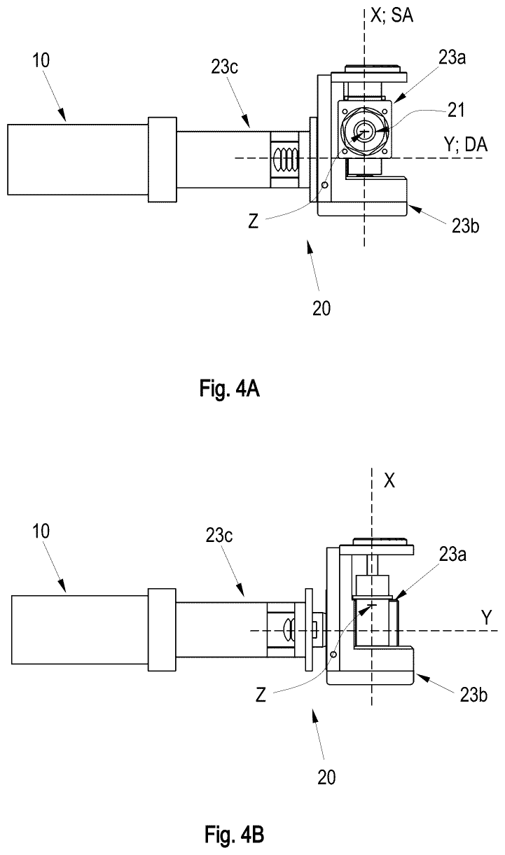

FIGS. 1A to FIG. 4B show a milling system according to the invention, in which FIGS. 1A and 1B are perspective views, FIGS. 2A and 2B are lateral views, FIGS. 3A and 3B are views from the front and FIGS. 4A and 4B are plan views of the milling system. FIGS. 1A, 2A, 3A, and 4A show a milling system with a milling tool pivoted upward and FIGS. 1B, 2B, 3B, and 4B show a milling system with a milling tool pivoted downward. FIGS. 1A to FIG. 4B will be described collectively below.

The milling system 1 according to the invention substantially comprises a motor unit 10 and a milling head 20. The motor unit 10 is coupled to the milling head 20. The milling head 20 in turn comprises a milling tool 21, which is movable along three movement axes X, Y and Z, wherein the movement axes X, Y and Z are preferably perpendicular to one another. However, the movement axes X, Y and Z may optionally also be arranged at different angles to one another, especially if the axis of rotation DA and/or pivot axis SA mentioned below is/are provided.

The movement of the milling tool 21 along the movement axis Y can be realized by means of a linear drive 22, for example a rack with a pinion assigned thereto. The pinion can be driven by the motor unit 10. Alternatively, a threaded spindle can also be provided instead of a rack and pinion. It is substantial to the invention that the milling tool 21 is movable along the movement axis Y, wherein drive means can be used which are suitable for causing a translational movement of the milling tool 21 along the movement axis Y.

Linear drives can also be provided for moving the milling tool 21 along the movement axes X and Z, which drives are coupled to the motor unit 10, for example via angular gears. Depending on the arrangement of the motor unit 10 relative to the linear drive 22 for the movement axis Y, this linear drive can also be coupled to the motor unit 10 via an angular gear.

The milling head substantially consists of three units, specifically:
a milling tool unit 23a on which the milling tool 21 is arranged,
a swivel fork 23b on which the milling tool unit 23a is arranged, and
a milling head guide 23c, on which the swivel fork 23b is arranged.

The linear drive 22 can be arranged in the milling head guide 23c. Alternatively, the milling head guide 23c can also be formed by the linear drive 22 itself. By means of the milling head guide 23c, the swivel fork 23b, and thus also the milling tool 21, is moved along the movement axis Y.

The milling tool unit 23a is arranged in the swivel fork 23b, i.e. between the two fork legs of the swivel fork 23b, and is coupled to a linear drive, for example a spindle drive. By means of this linear drive, the milling tool unit 23a can be moved back and forth between the two fork legs and relative to the swivel fork along the movement axis X, as a result of which the milling tool 21 is accordingly also moved back and forth along the movement axis X.

The milling tool 21 is arranged on the milling tool unit 23a and coupled to a linear drive, such as a spindle drive. By means of this linear drive, the milling tool 21 can be moved back and forth along the movement axis Z and relative to the milling tool unit.

By means of the three units 23a, 23b, 23c, the milling tool 21 can be positioned anywhere in the space, i.e. in the sewer, with respect to the three movement axes X, Y, Z, without a base unit, e.g. a carriage, on which the milling system is arranged, having to be moved.

In one embodiment of the invention, the milling head 20 is designed to be rotatable about an axis of rotation DA. The axis of rotation DA can be congruent with or parallel to the movement axis Y. By means of a corresponding drive, the motor unit 10 can rotate the milling head guide 23c about the axis of rotation DA so that the milling tool is also rotated about this axis of rotation DA. The angle of rotation is preferably up to 180°, very particularly preferably up to 360°.

Furthermore, it can be provided that the milling tool unit 23a is designed to be pivotable about a pivot axis SA relative to the swivel fork 23b, whereby the milling tool can be pivoted forward or downward, for example. The pivot axis SA can be congruent with or parallel to the movement axis X. The milling tool unit 23a is also pivoted by the motor unit 10, which is coupled to said milling tool unit via gear means suitable for this purpose. The pivot angle is preferably 180°, but can also be greater than 180°.

With the axis of rotation DA, the pivot axis SA and the three movement axes X, Y, Z, five degrees of freedom are available for positioning and aligning the milling tool in the sewer, which significantly increases the flexibility of the milling system according to the invention.

In FIGS. 1A, 2A, 3A, and 4A, the milling tool unit 23a is facing upward and is located approximately midway between the fork legs of the swivel fork 23b. The milling tool unit 23a is in a neutral position relative to the movement axis X.

In FIGS. 1B, 2B, 3B, and 4B, however, the milling tool unit 23a is facing downward and is located approximately on the left fork leg of the swivel fork 23b.

In the embodiment of the milling system 1 according to the invention shown here, the motor unit 10 is coupled to the three units of the milling head by means of a gear unit, in particular an angular gear unit, wherein each movement axis X, Y, Z is assigned a gear of the gear unit. The pivot axis SA and the axis of rotation DA can also each be assigned a gear of the gear unit.

The motor unit may comprise a plurality of motors, each motor being coupled to a gear of the gear unit.

In an alternative, but still inventive, embodiment of the invention, the motor unit can comprise a plurality of motors, in particular electric motors. Each of these motors is assigned to a movement axis or the axis of rotation and the pivot axis. These motors can be directly arranged on the corresponding axis, which means that some of the gears can be dispensed with or at least greatly simplified.

For example, the motor assigned to the movement axis X can be arranged in a fork leg of the swivel fork 23b. The motor assigned to the pivot axis can then be arranged in the other fork leg of the swivel fork 23b. The motor assigned to the movement axis Z can, for example, be arranged in the milling tool unit 23a. The motor assigned to the movement axis Y and the motor assigned to the axis of rotation DA can, for example, be arranged in the milling head guide 23c.

The drive of the milling tool 21 can be arranged in the milling tool unit 23a, or can be coupled to a motor of the motor unit by means of appropriate gear means.

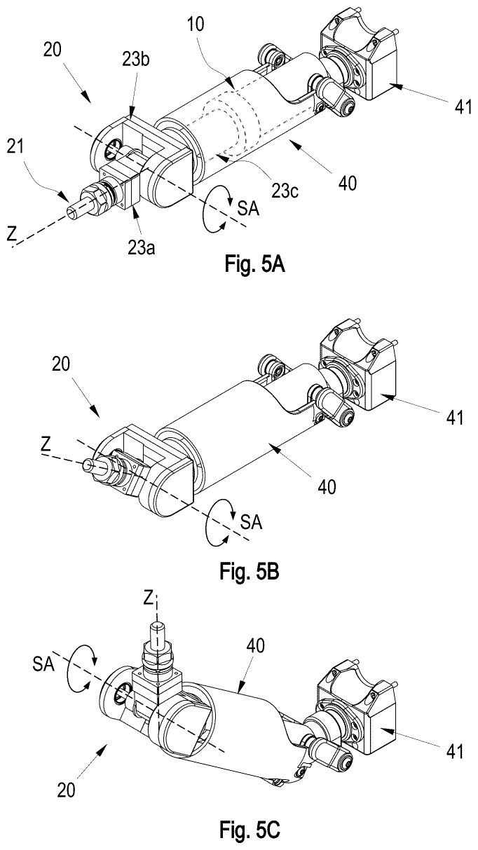

FIGS. 5A-5C are perspective views of a milling system 1 according to the invention, which is arranged on a lifting system 40 of a carriage, in different positions of the lifting system and different positions of the milling tool 21.

The lifting system 40 comprises a tube here which can be fastened to a carriage (not shown here) by means of a bracket 41. Between the tube and the bracket are swivel means with which the tube can be pivoted up and down relative to the carriage. Optionally, these swivel means can also be designed to additionally pivot the tube to the right and to.

The milling system 1 according to the invention is arranged in the front end portion of the tube, wherein the milling head 21 is located outside the tube. The motor unit 10 is arranged in the tube where it is locked in position.

With the lifting system 40, the entire milling system 1 can be raised or lowered relative to the carriage (or optionally also pivoted to the side). This is particularly advantageous when milling work has to be carried out in sewer pipes having large diameters. The milling system 1 can then, for example, first be lifted by the lifting system and brought close to the location to be machined. The milling tool is then aligned with precision by or using the milling system 1 according to the invention.

FIG. 5A shows a largely horizontal lifting system, wherein the milling tool unit 23a is pivoted about the pivot axis SA such that the milling tool 21 is facing forward.

FIG. 5B, the lifting system is also largely horizontal. The milling tool unit 23a is pivoted about the pivot axis SA here in such a way that it is facing slightly upward with respect to the milling head 1.

FIG. 5C, the lifting system is pivoted to by a certain angle. The milling tool unit 23a is pivoted about the pivot axis SA such that it is facing slightly upward relative to the milling head 1. Due to the combination of the pivot angle of the lifting system and the pivot angle of the milling tool unit 23a, the milling tool 21 is virtually vertical.

In an alternative embodiment of the invention, instead of a tube, a lifting arm, which can be arranged on a carriage and can be pivoted upward relative to the carriage, can be provided as the lifting system. The milling system 1 can then be arranged at the free end of the lifting arm.

Alternatively, the lifting arm can have at least two lifting arm portions which are coupled to one another in an articulated manner, preferably via a swivel joint. The free end of one of the two lifting arm portions can be deflectably or pivotally arranged on the carriage. The milling system 1 can then be arranged at the free end of the other lifting arm portion.

The free end of one of the two lifting arm portions can optionally be deflectably or pivotally arranged on a main support, which in turn is arranged on the carriage so as to be rotatable relative to the carriage.

As with the tube mentioned above, the milling system 1 can also be initially lifted by the lifting arm and brought close to the location that is to be machined. The milling tool is then aligned with precision by or using the milling system 1 according to the invention.

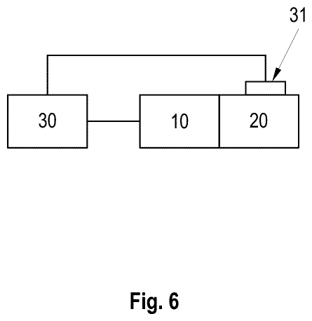

FIG. 6 shows a block diagram of a milling system according to the invention.

The motor unit 10 is coupled to the milling head 20, as described above with reference to FIGS. 1A to FIG. 4B. Alternatively, the motor unit 10 can have a plurality of motors, each of which can be arranged on the corresponding axis (movement axes, axis of rotation and pivot axis) in the milling head 20, as described in the alternative embodiment relating to FIGS. 1A to FIG. 4B.

In addition to the motor unit and the milling head, the milling system according to the invention comprises a control device 30 which is coupled to the motor unit 10. The control device 30 controls the motor unit or the motors of the motor unit using open-loop/closed-loop control.

In one embodiment of the invention, the control device 30 can be coupled to an operating unit (not shown here) arranged outside the sewer. Staff can control the milling system by means of the operating unit using open-loop control. Corresponding open-loop control instructions are transmitted from the operating unit to the control device 30. The control device 30 can be designed such that it converts the received control instructions into a control instruction for the corresponding motors and controls the motors accordingly using open-loop control.

For example, the operating staff can specify a coordinate in the space (sewer) toward which the milling tool 21 is to be moved. The control device 30 can then, for example, use the specified coordinate and the current position of the milling tool 21 to determine a path along which the milling tool 21 must be moved in order to reach the desired position. The motors are then each controlled using open-loop control such that the milling tool 21 moves along this path.

In one example, the operating staff may instruct the control device 30 (e.g., by specifying coordinates) to move the milling tool 21 toward the center of a side inlet that is covered by a pipe liner. Next, the operating staff can instruct the control device 30 (e.g. by specifying the diameter of the side inlet and the diameter of the sewer pipe) to open the side inlet, i.e. to remove the pipe liner in the region of the side inlet using the milling tool. On the basis of the diameter of the side inlet, the diameter of the sewer pipe and the current position of the milling tool, the control device can determine which path (and, optionally, at which feed rate) the milling tool must be moved to completely release the side inlet. Another advantage of the milling system according to the invention is clear here: since the milling tool can be moved along a predetermined path, relatively milling tools are also sufficient to machine large regions. I can to this example a small milling tool be guided along the edge of the side path to expose the side inlet-the pipe liner to be removed is therefore cut out along the edge of the side path using the milling tool. The restoring forces acting on the milling system are thus minimized, which also minimizes the forces acting on a vehicle (on which the milling system is arranged).

The control device 30 may comprise storage means in which a predefined program sequence (or a plurality of predefined program sequences) may be stored. Using the predefined program sequences, the control device can control the motor unit in a predetermined manner. For example, a predefined program sequence can be provided to bring the milling head into a neutral position, as shown, for example, in FIG. 5A. Such predefined program sequences can be activated by the operating staff via the operating unit. In one embodiment, a plurality of predefined program sequences can be executed one after the other in a sequence that may also be established by the operating staff. This allows a milling process to be carried out partially or fully automatically.

One or more sensors 31 can be provided on the milling head 1, with which certain milling parameters can be recorded and monitored. For example, a force acting on the milling tool 21 or a torque acting on the milling tool 21 can be recorded by a force sensor. Additional sensors for other milling parameters can be provided.

Based on the measured values from the sensors, the control device 30 can control the milling process using open-loop or closed-loop control. If, for example, the torque of the milling tool exceeds a certain value, the control device 30 can, for example, prompt the motor assigned to the movement axis Z to move the milling tool back along the movement axis Z until the detected value of the torque falls below a predetermined value (or alternatively to interrupt the advancement of the milling tool along the movement axis Z until the detected torque falls below a predetermined value).

The sensors or the measured values detected by the sensors can be used (preferably by the control device) to correctively intervene in the milling process. For example, a member of staff can instruct the milling system to release a pipe liner (as described in the example above). Under ideal conditions, the milling tool is moved along the desired path and the pipe liner to be removed is cut out. However, ideal conditions are very rarely found, especially in a sewer. For example, while moving along the desired path, the milling tool may encounter an obstacle, for example, that causes the lateral pressure on the milling tool to increase beyond a certain value. If a corresponding sensor is provided for this purpose, the control device can intervene to correct the milling process by stopping movement in the direction of the obstacle or by reducing advancement in the direction of the obstacle, for example until the lateral pressure falls below a certain value again. Another example of corrective intervention would be the temperature of the milling tool: if a certain temperature value is exceeded (which can be detected by an appropriate temperature sensor), the rotational speed of the milling tool can be reduced, for example.

Predefined program sequences can be provided for corrective intervention in the milling process, which can also be stored in the memory apparatus of the control device. Such program sequences can be linked to conditions. For example, the condition for a predefined program sequence with which the rotational speed of the milling tool can be gradually reduced can be: “Temperature>150° C.”. If this condition occurs, the control device can interrupt the current sequence of the milling process and execute the predefined program sequence. After completion of the predefined program sequence, for example when the temperature has fallen below a certain value again, the “normal” sequence of the milling process can be resumed. Such corrective intervention in the milling process can also be provided if the milling process is completely controlled by the operating staff. Any corrective intervention can be displayed to operating staff on the control unit (even if the milling process is partially or completely automatic).

With the corrective intervention, damage to the milling tool, the milling system or even the carriage on which the milling system is arranged can be prevented or even avoided. The service life of the entire system can thus be significantly increased as wear is reduced.

We claim:

1. A milling system for the rehabilitation of a sewer, in particular a wastewater sewer, comprising
a motor unit, and
a milling head on which a milling tool is arranged, wherein
the milling head is coupled to the motor unit and the milling tool is movable along at least one movement axis, and
the motor unit is coupled to the milling head in such a way that it can cause the milling tool to move along at least one movement axis.

2. The milling system according to claim 1, wherein the at least one movement axis comprises
a first movement axis (X),
a second movement axis (Y), and
a third movement axis (Z),
wherein the milling tool is movable along the first, second and/or third movement axes (X; Y; Z), and wherein the motor unit is coupled to the milling head in such a way that it can cause the milling tool to move along the first, second and/or third movement axes (X; Y; Z).

3. The milling system according to claim 2, wherein the motor unit is coupled to the milling head by means of a gear unit, in particular an angular gear unit, wherein each movement axis (X; Y; Z) is assigned a gear of the gear unit, wherein the gears of the gear unit can be operated independently of one another.

4. The milling system according to claim 2, wherein the motor unit comprises a plurality of motors, in particular electric motors, wherein each movement axis (X; Y; Z) is assigned a motor of the plurality of motors, and wherein each motor is adapted to move the milling tool along the corresponding movement axis (X; Y; Z).

5. The milling system according to claim 3, wherein
the milling head is rotatable about an axis of rotation (DA), and/or
the milling tool can be pivoted about a pivot axis (SA),
wherein the axis of rotation (DA) and/or the pivot axis (SA) is/are each assigned a gear of the gear unit or a motor of the plurality of motors.

6. The milling system according to claim 1, wherein the milling system further comprises a control device which is coupled to a sensor system and the motor unit, wherein the control device is adapted to control the motor unit on the basis of the measured values detected by the sensor system.

7. The milling system according to claim 6, wherein the sensor system comprises
at least one force sensor for detecting at least one force acting on the milling tool, and/or
a temperature sensor for detecting a temperature of the milling tool, and/or
a torque sensor for detecting the torque acting on the milling tool.

8. The milling system according to claim 6, wherein the control device is adapted to control the motor unit according to a predetermined program sequence.

9. The milling system according to claim 1, wherein said system can be arranged directly or indirectly on a carriage of a sewer inspection system.

10. The milling system according to claim 9, wherein said milling system is arranged at a free end of a lifting system, wherein the lifting system is arranged on the carriage.

11. A sewer inspection system comprising a carriage and a milling system for the rehabilitation of a sewer, in particular a wastewater sewer, wherein the milling system comprises
a motor unit, and
a milling head on which a milling tool is arranged, wherein
the milling head is coupled to the motor unit and the milling tool is movable along at least one movement axis, and
the motor unit is coupled to the milling head in such a way that it can cause the milling tool to move along at least one movement axis.

12. The sewer inspection system according to claim 11, wherein the at least one movement axis comprises
a first movement axis (X),
a second movement axis (Y), and
a third movement axis (Z),
wherein the milling tool is movable along the first, second and/or third movement axes (X; Y; Z), and wherein the motor unit is coupled to the milling head in such a way that it can cause the milling tool to move along the first, second and/or third movement axes (X; Y; Z).

13. The sewer inspection system according to claim 12, wherein the motor unit is coupled to the milling head by means of a gear unit, in particular an angular gear unit, wherein each movement axis (X; Y; Z) is assigned a gear of the gear unit, wherein the gears of the gear unit can be operated independently of one another.

14. The sewer inspection system according to claim 12, wherein the motor unit comprises a plurality of motors, in particular electric motors, wherein each movement axis (X; Y; Z) is assigned a motor of the plurality of motors, and wherein each motor is adapted to move the milling tool along the corresponding movement axis (X; Y; Z).

15. The sewer inspection system according to claim 14, wherein
the milling head is rotatable about an axis of rotation (DA), and/or
the milling tool can be pivoted about a pivot axis (SA),
wherein the axis of rotation (DA) and/or the pivot axis (SA) is/are each assigned a gear of the gear unit or a motor of the plurality of motors.

16. The sewer inspection system according to claim 11, wherein the milling system further comprises a control device which is coupled to a sensor system and the motor unit, wherein the control device is adapted to control the motor unit on the basis of the measured values detected by the sensor system.

17. The sewer inspection system according to claim 16, wherein the sensor system comprises
at least one force sensor for detecting at least one force acting on the milling tool, and/or
a temperature sensor for detecting a temperature of the milling tool, and/or
a torque sensor for detecting the torque acting on the milling tool.

18. The sewer inspection system according to claim 16, wherein the control device is adapted to control the motor unit according to a predetermined program sequence.

19. The sewer inspection system according to claim 11, wherein said system can be arranged directly or indirectly on a carriage of a sewer inspection system.

20. The sewer inspection system according to claim 19, wherein said milling system is arranged at a free end of a lifting system, wherein the lifting system is arranged on the carriage.
